(19) United States
(12) Patent Application Publication
(10) Pub. No.: US 2007/0238611 A1
(43) Pub. Date: Oct. 11, 2007

(54) CARBON DIOXIDE ABSORBENT, CARBON DIOXIDE SEPARATION APPARATUS AND REFORMING APPARATUS

(76) Inventors: Toshihiro IMADA, Yokohama-shi (JP); Masahiro Kato, Naka-gun (JP); Kenji Essaki, Kawasaki-shi (JP); Yasuhiro Kato, Yokohama-shi (JP); Yukishige Maezawa, Hachioji-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/551,955

(22) Filed: Oct. 23, 2006

(30) Foreign Application Priority Data
Mar. 24, 2006 (JP) 2006-083365

(51) Int. Cl. B01J 20/04

(52) U.S. Cl. 502/400; 48/128; 48/127.9; 422/243

(57) ABSTRACT

The carbon dioxide absorbent contains a lithium-containing oxide, an alkali halide, has a high carbon dioxide absorption capability, and sufficiently maintains the carbon dioxide absorption capability even in repeated used for absorption and desorption of carbon dioxide.

### CROSS-REFERENCE TO RELATED APPLICATIONS

This application is based upon and claims the benefit of priority from prior Japanese Patent Application No. 2006-083365, filed Mar. 24, 2006, the entire contents of which are incorporated herein by reference.

### BACKGROUND OF THE INVENTION

1. Field of the Invention

The invention relates to a carbon dioxide absorbent, a carbon dioxide separation apparatus, and a reforming apparatus.

2. Description of the Related Art

A generator, for example, is provided with a combustion apparatus for burning fuel containing hydrocarbons as main components. In this combustion apparatus, it is effective to carry out separation and recovery of carbon dioxide from an exhaust gas near the combustion chamber where the carbon dioxide concentration is high. Such a recovery site of carbon dioxide is often at a high temperature of 300° C. or higher.

Separation and recovery of carbon dioxide is carried out by, for example, a reforming reaction. Specifically, after a reforming reaction which fossil fuel reacts with steam to produce hydrogen as a main product and carbon dioxide and carbon monoxide as a byproduct, the carbon dioxide is separated. Further, in chemical engineering process, a steam reforming reaction for producing hydrogen as a main product and carbon dioxide as a byproduct by reaction of carbon monoxide and steam is carried out. Hydrogen obtained by these reactions is used as fuel or a starting material and therefore it is required to increase the production efficiency of hydrogen. Particularly, in the reaction like the reforming by which carbon dioxide is produced as a byproduct, the chemical equilibrium is shifted to the main product production side by removing carbon dioxide from the reaction field. As a result, the production efficiency of hydrogen, the main product, can be increased. The reforming reaction is carried out at a temperature of 400° C. or higher.

As a technique of separating carbon dioxide from a gas, a chemical absorption process using an alkanol amine type solvent, a pressure swing method, a low temperature separation method, and a membrane separation method are conventionally known.

However, these methods all require the gas which is to be introduced to be at a temperature around 200° C. or lower because of the limited heat resistance of materials and substances such as membranes and solvents to be employed for the carbon dioxide separation.

It is required to carry out separation and recovery of carbon dioxide contained in an exhaust gas discharged from a combustion apparatus for burning fuel containing hydrocarbons as main components in an environment of 300° C. or higher. Also, it is required to carry out separation and recovery of carbon dioxide in reforming reaction in an environment of 400° C. or higher. As a result, since the temperature of the gas to be separated and recovered has to be suppressed to about 200° C. or lower in conventional methods, it has been difficult to remove carbon dioxide from an exhaust gas discharged from the above-mentioned conventional combustion apparatus and product gases obtained by reforming reaction.

Accordingly, carbon dioxide separation methods using lithium-containing oxides reactive with carbon dioxide without a cooling step of a high temperature gas containing carbon dioxide at temperatures exceeding 500° C. have been investigated. JP-A 2002-274809(KOKAI) discloses a method of removing carbon dioxide from a high temperature reaction field at a temperature exceeding 400° C. and efficiently obtaining a main product by filling a reactor which carries out reforming reaction with a lithium-containing oxide such as lithium zirconate and lithium silicate. For example, in the case of a methane steam reforming system using a chemical reaction apparatus filled with methane reforming catalyst and lithium silicate, the steam reforming reaction of methane according to the following reaction formula (1) and absorption reaction of carbon dioxide with lithium silicate according to the following reaction formula (2) are simultaneously caused at 400 to 650° C.

CH₄+2H₂O [symbol] 4H₂+CO₂ (1)

Li₄SiO₄+CO₂ [symbol] Li₂CO₃+Li₂SiO₃ (2)

The reaction of the lithium silicate and carbon dioxide defined by the formula (2) is promoted rightward and the absorption reaction of carbon dioxide is promoted fastest at about 600° C. The carbon dioxide absorption reaction temperature range changes depending on the carbon dioxide concentration in the reaction atmosphere and as the carbon dioxide concentration is increased, the upper limit temperature of the absorption temperature region becomes higher. Removal of carbon dioxide from the field of steam reaction of methane using lithium silicate shifts the reaction equilibrium of the formula (1) to the rightward hydrogen production reaction, thereby promoting the methane reforming reaction and improving the hydrogen production efficiency. Lithium silicate having absorbed carbon dioxide causes the reaction defined by the above-mentioned formula (2) leftward by heating and desorbs carbon dioxide and thus the lithium silicate can be regenerated. Accordingly, a method of removing carbon dioxide by filling a reactor for reforming reaction with lithium silicate and efficiently obtaining hydrogen, a main product, can be carried out repeatedly.

However, only with lithium silicate, the carbon dioxide absorption speed is slow and particularly, in a reaction atmosphere in which the carbon dioxide concentration is low, a sufficient absorption speed cannot be achieved.

Accordingly, JP-A 2001-96122 (KOKAI) describes improvement of the carbon dioxide absorption speed and increase of the absorption property by adding an alkali carbonate such as potassium carbonate and sodium carbonate for efficiently absorbing carbon dioxide in a low concentration. However, in the case of using lithium silicate mixed with an alkali carbonate as a carbon dioxide absorbent for absorbing carbon dioxide in a produced gas at the time of reforming reaction, it is found that the added alkali carbonate is decreased because of vaporization or the like from the absorbent. Therefore, in the case of repeated use, the carbon dioxide absorption property of the lithium silicate is decreased. Moreover, since the vaporized alkali component poisons a reforming catalyst which promotes the reforming reaction, the catalytic function is decreased.

### BRIEF SUMMARY OF THE INVENTION

According to a first aspect of the present invention, there is provided a carbon dioxide absorbent comprising a lithium-containing oxide and an alkali halide.

According to a second aspect of the present invention, there is provided a carbon dioxide separation apparatus comprising:

a reactor having a introduction tube and a discharge tube;

a carbon dioxide absorbent charged in the reactor and containing a lithium-containing oxide and an alkali halide; and

a heater installed in the outer circumference of the reactor for supplying heat to the reactor.

According to a third aspect of the present invention, there is provided a reforming apparatus comprising:

a reactor having an introduction tube to introduce steam and a starting material gas containing carbon, and a discharge tube to discharge produced gases;

a reforming catalyst charged in the reactor to promote the reforming reaction;

a carbon dioxide absorbent charged in the reactor and containing a lithium-containing oxide and an alkali halide; and

a heater installed in the outer circumference of the reactor to supply heat to the reactor.

### BRIEF DESCRIPTION OF THE SEVERAL VIEWS OF THE DRAWING

FIG. 1 is a schematic cross-sectional view showing a carbon dioxide separation apparatus according to an embodiment; and

FIG. 2 is a schematic view showing a reforming reaction apparatus according to an embodiment.

### DETAILED DESCRIPTION OF THE INVENTION

Hereinafter, a carbon dioxide absorbent, a carbon dioxide separation apparatus, and a reforming reaction apparatus according to embodiments of the inventions will be described in detail.

The carbon dioxide absorbent of an embodiment contains lithium-containing oxide and at least one kind of alkali halides.

Examples usable as the lithium-containing oxide may include lithium zirconate (Li₂ZrO₃), lithium ferrite (LiFeO₂), and lithium orthosilicate (Li₄SiO₄). Among them lithium orthosilicate is preferable since it has a high temperature of the boundary between absorption and desorption and is capable of separating carbon dioxide at a high temperature and further absorbing carbon dioxide at high speed. This lithium orthosilicate may have a composition slightly different from stoichiometric ratio shown as the chemical formula. The carbon dioxide absorption reaction formula (3) and regeneration formula (4) of the lithium orthosilicate are as follows.

Absorption: Li₄SiO₄+CO₂→Li₂SiO₃+Li₂CO₃ (3)

Regeneration: Li₂SiO₃+Li₂CO₃→Li₄SiO₄+CO₂ (4)

The lithium orthosilicate absorbs carbon dioxide as defined by the above-mentioned formula (3) by heating in an absorption temperature range (the first temperature) from a room temperature to about 70° C., and produces lithium metasilicate (Li₂SiO₃) and lithium carbonate (Li₂CO₃). The carbon dioxide absorbent having absorbed carbon dioxide is heated at a temperature (the second temperature) exceeding the above-mentioned absorption temperature range, so that carbon dioxide is desorbed as defined by the above-mentioned formula (4) and the absorbent is regenerated in the form of the original lithium orthosilicate. Such carbon dioxide absorption by the carbon dioxide absorbent and carbon dioxide desorption for regeneration of the carbon dioxide absorbent can be carried out repeatedly. The absorption temperature range of carbon dioxide depends on the carbon dioxide concentration of the reaction atmosphere and as the carbon dioxide concentration is increased more, the upper limit temperature of the absorption temperature range is increased.

The lithium-containing oxide is used in the form of particles (or a powder) and preferably has an average particle diameter of 0.1 to 10 μm. If the average particle diameter of the lithium-containing oxide is smaller than 0.1 μm, the particles (or a powder) of the lithium-containing oxide are possible to be agglomerated. If the average particle diameter of the lithium-containing oxide particle (or powder) exceeds 10 μm, the contact surface area with carbon dioxide is narrowed and the carbon dioxide absorption speed may possibly be lowered.

Examples of the above-mentioned alkali halide include halides of sodium, potassium, and lithium. Particularly lithium halides such as lithium chloride and lithium bromide are preferable. The lithium halide can stably exist in liquefied lithium carbonate produced along with absorption of carbon dioxide with the coexisting lithium-containing oxide. One or more alkali halides may be used.

Although even a very small amount of the alkali halide existing in the carbon dioxide absorbent causes an effect to increase the carbon dioxide absorption capability, it is preferable to add the alkali halide in an amount of 0.5 to 40% by mole of based on the total amount of the lithium-containing oxide and the alkali halide. If the content of the alkali halide exceeds 40% by mole, the effect of the alkali halide to improve the carbon dioxide absorption property is saturated. Additionally, since the ratio of the lithium-containing oxide in the carbon dioxide absorbent is decreased, the carbon dioxide absorption amount and the carbon dioxide absorption speed of the carbon dioxide absorbent may possibly be lowered. The alkali halide is more preferably in an amount of 1 to 10% by mole based on the total amount of the lithium-containing oxide and the alkali halide.

The above-mentioned alkali halide is used in the form of, for example, granules (or a powder), and although the particle diameter thereof is not particularly limited, it is preferable to adjust the average particle diameter to be 0.1 to 10 μm. If the average particle diameter of the alkali halide exceeds 10 μm, it takes a long time to form an eutectoid and the carbon dioxide absorption speed may possibly be decreased.

The carbon dioxide absorbent of the embodiment is allowed to contain a titanium-containing oxide such as potassium titanate, titanium oxide, and lithium titanate. These titanium-containing oxides have a function of preventing particles of the lithium-containing oxide in the carbon dioxide absorbent from becoming large. The titanium-containing oxide is preferable to be contained in an amount of 80% by weight or less based on the total amount of the lithium-containing oxide and the titanium-containing oxide. If the content of the titanium-containing oxide exceeds 80% by weight, the ratio of lithium-containing oxide is lowered and the carbon dioxide absorption amount and the carbon dioxide absorption speed of the carbon dioxide absorbent may possibly be lowered. The titanium-containing oxide is more preferably in an amount of 10 to 40% by weight based on the total amount of the lithium-containing oxide and the titanium-containing oxide.

The shape of the carbon dioxide absorbent of the embodiment is not particularly limited. The carbon dioxide absorbent may be used in the form of a powder mixture obtained by, for example, mixing a lithium-containing oxide powder and an alkali halide powder respectively having an average particle diameter of 0.1 to 10 μm. Further, the carbon dioxide absorbent may be used in the form of a molded body obtained by compressive molding, granulating, or extrusion molding the lithium-containing oxide and the alkali halide. In the case of the molded body, it is preferable to increase the contact surface area with carbon dioxide by making the molded body be porous pellets or honeycomb structure with a high carbon dioxide ventilation property. The porous body preferably contains the lithium-containing oxide and alkali halide in the form of particles respectively having an average particle diameter of 0.1 to 10 μm and having a porosity of 30 to 75%.

The carbon dioxide absorbent (of lithium silicate as the lithium-containing oxide) in the form of such a porous body can be produced by the following method.

At first, silicon dioxide and lithium carbonate are weighed at a mole ratio of silicon dioxide to lithium carbonate to be 1:2 and mixed in an agate mortar for about 0.1 to 1 hour. The obtained powder mixture is put in an aluminum crucible and heated for 0.5 to 20 hours in the air in a box type electric furnace to obtain a lithium orthosilicate powder. A prescribed amount of the alkali halide is added to the lithium orthosilicate powder and mixed in dry state. Successively, a prescribed amount of the lithium orthosilicate powder mixed with the alkali halide is weighed, charged in a die and compressively molded to produce the carbon dioxide absorbent in a porous structure.

According to the above described embodiment, it is made possible to provide the carbon dioxide absorbent having high carbon dioxide absorption capability, keeping the carbon dioxide absorption capability sufficient for repeated use for absorption and desorption of carbon dioxide, and provided with a long life.

That is, conventionally, to improve carbon dioxide absorption property and to efficiently absorb carbon dioxide in a low concentration, an alkali carbonate such as potassium carbonate has been added to lithium-containing oxide. However, in the case where carbon dioxide absorption reaction and desorption reaction are repeated many times by a carbon dioxide absorbent containing potassium carbonate, the carbon dioxide absorption capability is gradually decreased.

The inventors of the invention have made various investigations on the decrease of the carbon dioxide absorption capability of the carbon dioxide absorbent and have found that that potassium carbonate in the carbon dioxide absorbent is decreased during the repeated absorption reaction and desorption reaction.

Therefore, the inventors of the invention have found that use of an alkali halide as a promoting material for carbon dioxide absorption reaction in place of the alkali carbonate can provide a long-life carbon dioxide absorbent having an improved carbon dioxide absorption capability and maintaining sufficient carbon dioxide absorption capability even after carbon dioxide absorption reaction and desorption reaction are repeated many times. The above-mentioned alkali halide liquefies lithium carbonate in solid phase formed in the surface of the lithium-containing oxide (e.g. lithium orthosilicate) along with the proceeding of carbon dioxide absorption and increases the diffusion speed of carbon dioxide. Accordingly, the absorption speed of carbon dioxide is increased. Further, the alkali halide exists stably in the liquefied lithium carbonate and remains in the carbon dioxide absorbent without being vaporized, so that the sufficient carbon dioxide absorption capability can be maintained even if it is used repeatedly.

The carbon dioxide absorbent of the embodiment in such a constitution is usable for separating and recovering carbon dioxide from exhaust gases emitted from power plants, chemical plants, and automobiles using hydrocarbons as starting materials or fuel.

Next, a carbon dioxide separation apparatus of another embodiment will be described.

The carbon dioxide separation apparatus comprises reactors each having a introduction tube and a discharge tube, the above-mentioned carbon dioxide absorbent containing the lithium-containing oxide and the alkali halide charged in the reactors, and heater installed in the outer circumference of the reactors for supplying heat to the reactors.

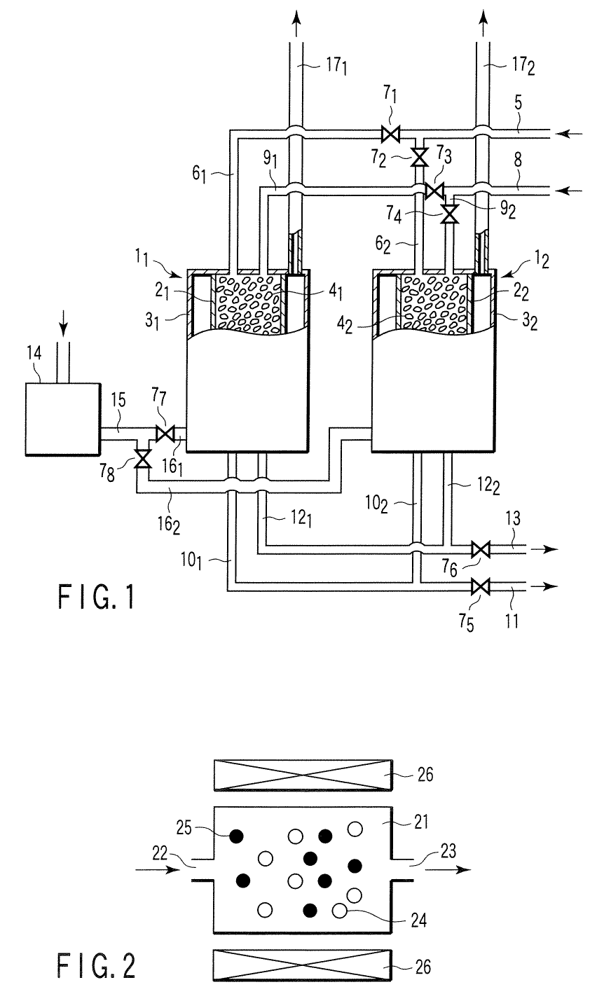

Hereinafter, the carbon dioxide separation apparatus of the embodiment will be described more specifically with reference to the schematic cross-sectional view shown in FIG. 1.

First and second absorption cylinders 1₁ and 1₂ have a double structure composed of inner tubes 2₁ and 2₂ and outer tubes 3₁ and 3₂. Herein, the inner tubes 2₁ and 2₂ form reactors and the space between the inner tubes 2₁ and 2₂ and the outer tubes 3₁ and 3₂ formed in the outer circumference is kept as the heater for supplying a heat. The above-mentioned carbon dioxide absorbents 4₁, 4₂ are charged in the reactors. First and second carbon dioxide-containing gas supply branched tubes 6₁ and 6₂ branched from a carbon dioxide-containing gas supply tube 5 are respectively joined to the upper parts of the respective reactors. First and second valves 7₁ and 7₂ are installed respectively in the first and second gas supply branched tubes 6₁ and 6₂.

First and second gas supply branched tubes 9₁ and 9₂ branched from a gas supply tube 8 for carbon dioxide recovery are joined to the upper parts of the respective reactors. Third and fourth valves 7₃ and 7₄ are installed respectively in the first and second gas supply branched tubes 9₁ and 9₂.

First and second gas discharge branched tubes 10₁ and 10₂ are joined to the lower parts of the respective reactors and the other ends of these branched tubes 10₁ and 10₂ are joined to a treated gas discharge tube 11. A fifth valve 7₅ is installed in the discharge tube 11. First and second recovered gas discharge branched tubes 12₁ and 12₂ are respectively joined to the respective reactors and the other ends of these branched tubes 12₁ and 12₂ are joined to a recovered gas discharge tube 13. A sixth valve 7₆ is installed in the recovered gas discharge tube 13.

A combustor 14 for burning fuel gas is installed adjacent to the first absorption cylinder 1₁. First and second combustion gas supply branched tubes 16₁ and 16₂ which are branched from a combustion gas supply tube 15 whose one end is connected to the combustor 14 are joined to the faces in the lower side of the respective heater. Seventh and eighth valves 7₇ and 7₈ are installed respectively in the first and second combustion gas supply branched tubes 16₁ and 16₂. The first and the second exhaust tubes 17₁ and 17₂ are joined to and communicated with the respective heater. When fuel gas is introduced into the combustor 14, the combustion gas burned here is supplied to the respective heater through the combustion gas supply tube 15 and the first and second supply branched tubes 16₁ and 16₂, passes in these spaces and is discharged out of the first and second exhaust tubes 17₁ and 17₂. During the time when the combustion gas passes the spaces, the carbon dioxide absorbents 4₁ and 4₂ charged in the respective reactors are heated.

The number of moles of the gas flowing to the respective reactors per unit time is preferable to be set about at least 4 times and at highest 50 times as much as the number of moles of the charged carbon dioxide absorbents 4₁ and 4₂. If the number of moles of the flowing gas per unit time exceeds at highest 50 times as much, it becomes difficult to efficiently absorb carbon dioxide in terms of the capacity utilization factor of the reactors. On the other hand, if the number of moles of the flowing gas per unit time is lower than 4 times as much, the heat generation amount following the absorption reaction becomes so high that the absorption reaction itself may possibly be inhibited because of the temperature increase of the flowing gas. In term of both the utilization factor of the absorption cylinder capacity and swift proceeding of the absorption reaction, the number of moles of the flowing gas per unit time is more preferable to be set about at least 8 times and at highest 30 times as much.

In the two reactors containing the carbon dioxide absorbents 4₁ and 4₂ the carbon dioxide absorption reaction and carbon dioxide desorption reaction are reciprocally carried out as the following procedures (1-1) and (1-2) to continuously absorb and recover carbon dioxide.

(1-1) Carbon Dioxide Absorption Process in the First Absorption Cylinder 1₁

At first, the first valve 7₁ installed in the first branched tube 6₁ joined to the inner tube 2₁ (the first reactor) of the first absorption cylinder 1₁ and the fifth valve 7₅ installed in the treated gas discharge tube 11 are opened, and the valves 7₂, 7₃, 7₄, 7₆, 7₇, and 7₈ other than these valves are closed. A carbon dioxide-containing gas is supplied to the first reactor from the carbon dioxide supply tube 5 through the first branched tube 6₁. At this time, since the number of moles of the gas flowing to the first reactor per unit time is set to be at least about 4 times and at highest about 50 times as much as the number of moles of the charged lithium silicate as described above, carbon dioxide contained in the gas is quickly absorbed and kept in the carbon dioxide absorbent 4₁. The gas with a decreased carbon dioxide concentration is discharged through the first gas branched tube 10₁ and the treated gas discharge tube 11.

The carbon dioxide absorption process in the second absorption cylinder 1₂ is also similarly carried out.

(1-2) Carbon Dioxide Recovery Process in the Second Absorption Cylinder 1₂

During the time when the carbon dioxide absorption process in the first absorption cylinder 1₁ is carried out as described in (1-1), the fourth valve 7₄ installed in the second branched tube 9₂ joined to the second absorption cylinder 1₂, the sixth valve 7₆ installed in the recovered gas discharge tube 13, and the eighth valve 7₈ installed in the second combustion gas supply branched tube 16₂ are respectively opened. After that, the combustion gas from the combustor 14 is passed through the cyclic space (the second heater) composed of the inner tube 2₂ and the outer tube 3₂ via the combustion gas supply tube 1₅ and the second combustion gas supply branched tube 16₂, thereby heating the carbon dioxide absorbent 4₂ charged in the inner tube 2₂ (the second reactor) of the second absorption cylinder 1₂ to about 800° C. or higher. At the same time, a desired gas for recovery is supplied to the second reactor through the second branched tube 9₂ from the gas supply tube 8 for recovery. At this time, carbon dioxide already adsorbed in the carbon dioxide absorbent 4₂ is quickly desorbed by carbon dioxide desorption reaction and the gas containing carbon dioxide in a high concentration is recovered through the second recovered gas discharge branched tube 12₂ and the recovered gas discharge tube 13.

The carbon dioxide recovery from the first absorption cylinder 1₁ is also carried out by a similar process.

As described, at the time of carrying out the carbon dioxide absorption process in the first absorption cylinder 1₁, the process of recovering carbon dioxide from the second absorption cylinder 1₂ is carried out, and at the time of carrying out the carbon dioxide recovery process in the first absorption cylinder 1₁, the process of absorbing carbon dioxide in the second absorption cylinder 1₂ is carried out. These processes are reciprocally carried out to continuously separate and recover carbon dioxide.

The materials of the inner tubes 2₁ and 2₂; the outer tubes 3₁ and 3₂; the carbon dioxide-containing gas supply branched tubes 6₁ and 6₂; the recovery gas supply branched tubes 9₁ and 9₂; the gas discharge branched tubes 10₁ and 10₂; and the recovered gas discharge branched tubes 12₁ and 12₂ are not particularly limited and for example, dense alumina or metal such as nickel and iron can be used. In consideration of prolongation of the contact time of the combustion gas with the carbon dioxide absorbents 4₁ and 4₂, the reactors are preferable to have a tubular shape long in the gas flow direction.

As described above, according to the embodiment, a carbon dioxide separation apparatus economical and capable of continuously separating and recovering carbon dioxide can be provided.

Next, a reforming apparatus according to the embodiment will be described.

A reactor has an introduction tube to introduce a starting material gas containing carbon and steam and a discharge tube to discharge produced gases. A reforming catalyst is charged in the reactor for promoting the reforming reaction. A carbon dioxide absorbent containing the above-mentioned lithium-containing oxide and the alkali halide is charged in the reactor. Heating means is installed in the outer circumference of the reactor for supplying heat to the reactor.

The above-mentioned starting material gas containing carbon may be methane, natural gas and CO.

Examples to be used as the above-mentioned reforming catalyst may be catalytic metals such as nickel, ruthenium and rhodium supported on an alumina carrier.

It is preferable that the reforming catalyst and the carbon dioxide absorbent are charged in the reactor at a weight ratio of the reforming catalyst to the carbon dioxide absorbent to be in the range of 1:1 to 1:8.

The reforming apparatus of the embodiment will be described particularly with reference to the schematic drawing shown in FIG. 2.

A reactor 21 is provided with a gas introduction tube 22 and a produced gas discharge tube 23. A reforming catalyst 24 for promoting the reforming reaction and the above-mentioned carbon dioxide absorbent 25 are charged in the reactor 21. A heater 26 is installed in the upper and the lower side of the reactor 21.

In the reforming apparatus shown in FIG. 2, after the reforming catalyst 24 for promoting the reforming reaction and the carbon dioxide absorbent 25 are charged at a desired ratio in the reactor 21, a gas mixture of a starting material gas containing carbon (e.g., methane) and steam at a temperature of 500 to 650° C. is supplied to the reactor 21 through the gas introduction tube 22. At this time, in the presence of the above-mentioned reforming catalyst, the reforming reaction of steam defined by the above-mentioned formula (1) is promoted to produce hydrogen and at the same time, carbon dioxide is produced aside. The carbon dioxide produced as a byproduct is reacted with the lithium-containing oxide (e.g., lithium silicate) in the carbon dioxide absorbent charged in the reactor 21, which is a reforming reaction field, as defined by the above-mentioned formula (2) and absorbed and removed in the form of lithium carbonate from the reaction field. Removal of carbon dioxide produced as a byproduct in the reforming reaction field shifts the chemical equilibrium defined by the above-mentioned formula (1) to the hydrogen production side, and thus a product gas enriched with hydrogen can be obtained through the production gas discharge tube 22.

On the other hand, in the case where the absorption of carbon dioxide by the carbon dioxide absorbent 25 reaches the saturated state, the carbon dioxide absorbent 25 is heated to a temperature exceeding 700° C. (e.g., 850° C.) by the heater 26 to desorb carbon dioxide as defined by the formula (4) and regenerate the absorbent 25.

According to the embodiment described above, since the carbon dioxide absorbent containing the lithium-containing oxide and the alkali halide in combination with the reforming catalyst for promoting the reforming reaction are charged in the reactor into which the starting material gas containing carbon and steam are introduced, hydrogen as a main component gas and carbon dioxide produced as a byproduct at the reforming reaction are efficiently removed. Further, in the repeated use by regenerating the carbon dioxide absorbent, sufficiently high carbon dioxide absorption capability can be maintained. Accordingly, the reforming apparatus capable of efficiently producing hydrogen for a long duration can be provided.

That is, conventionally, to improve carbon dioxide absorption property and to efficiently absorb carbon dioxide in a low concentration, an alkali carbonate such as potassium carbonate has been added to lithium-containing oxide. However, in the case where absorption of carbon dioxide produced as a byproduct at the time of reforming reaction is carried out by a carbon dioxide absorbent containing potassium carbonate, the catalytic function is decreased. Also, in the case where carbon dioxide absorption reaction and desorption reaction are repeated many times in the reactor by a carbon dioxide absorbent containing potassium carbonate, the carbon dioxide absorption capability is gradually decreased.

The inventors of the invention have made various investigations on the deterioration of the catalytic function and have found that potassium evaporated from the above-mentioned carbon dioxide absorbent poisons the reforming catalyst which promotes the reforming reaction. Also, with respect to the deterioration of the carbon dioxide absorption capability of the carbon dioxide absorbent, the inventors of the invention have found that the potassium carbonate in the carbon dioxide absorbent is decreased during the repeated absorption reaction and desorption reaction.

Therefore, the inventors of the invention have investigated the effect of the use of an alkali halide as a promoting material for carbon dioxide absorption reaction in place of the alkali carbonate. As a result, the inventors of the invention have accomplished the reforming apparatus which can efficiently remove carbon dioxide produced as a byproduct together with hydrogen as a main product gas at the time of reforming reaction and can efficiently produce hydrogen for a long duration, since use of the alkali halide can maintain the catalytic function without poisoning the reforming catalyst for promoting the reforming reaction and also can maintain sufficiently high carbon dioxide absorption capability even if carbon dioxide absorption reaction and desorption reaction are repeated many times. The above-mentioned alkali halide can exist stably in liquefied lithium carbonate and remains in the carbon dioxide absorbent without being vaporized, so that unlike potassium carbonate, the alkali halide can maintain the catalytic function of the reforming catalyst for promoting the reforming reaction without poisoning the catalyst and maintain the sufficient carbon dioxide absorption capability even after repeated use. Also, the alkali halide liquefies the lithium carbonate in solid phase formed in the surface of the lithium-containing oxide (e.g., lithium orthosilicate) along with the proceeding of carbon dioxide absorption and increases the diffusion speed of carbon dioxide. Accordingly, the absorption speed of carbon dioxide is increased.

Hereinafter, the examples of the invention will be described.

### EXAMPLE 1

Silicon dioxide powder with an average particle diameter of 0.8 μm and lithium carbonate powder with an average particle diameter 1 μm were weighed at a mole ratio of silicon dioxide to lithium carbonate to be 1:2 and mixed in an agate mortar for about 10 minutes in dry state. The obtained powder mixture was heated at 1000° C. for 8 hours in the air in a box-type electric furnace to obtain a lithium orthosilicate powder. A lithium chloride powder with an average particle diameter of about 1 μm in an amount of 2% by mole based on the total amount of the lithium orthosilicate powder and the lithium chloride powder was added to the lithium orthosilicate powder and mixed in the agate mortar in dry state. The lithium orthosilicate powder mixed with the lithium chloride powder was put in a die with a diameter of 12 mm and pressure molded to produce porous pellets with a porosity of about 40% (a carbon dioxide absorbent).

### EXAMPLE 2

Porous pellets (a carbon dioxide absorbent) were produced in the same manner as Example 1, except that a lithium bromide powder with an average particle diameter of about 1 μm in an amount of 2% by mole based on the total amount of the lithium orthosilicate powder and the lithium bromide powder was added to the lithium orthosilicate powder.

### EXAMPLE 3

Porous pellets (a carbon dioxide absorbent) were produced in the same manner as Example 1, except that a lithium iodide powder with an average particle diameter of about 1 μm in an amount of 2% by mole based on the total amount of the lithium orthosilicate powder and the lithium iodide powder was added to the lithium orthosilicate powder.

### EXAMPLE 4

Porous pellets (a carbon dioxide absorbent) were produced in the same manner as Example 1, except that a lithium fluoride powder with an average particle diameter of about 1 μm in an amount of 2% by mole based on the total amount of the lithium orthosilicate powder and the lithium fluoride powder was added to the lithium orthosilicate powder.

### EXAMPLE 5

Porous pellets (a carbon dioxide absorbent) were produced in the same manner as Example 1, except that a potassium chloride powder with an average particle diameter of about 1 μm in an amount of 2% by mole based on the total amount of the lithium orthosilicate powder and the potassium chloride powder was added to the lithium orthosilicate powder.

### EXAMPLE 6

Porous pellets (a carbon dioxide absorbent) were produced in the same manner as Example 1, except that a sodium chloride powder with an average particle diameter of about 1 μm in an amount of 2% by mole based on the total amount of the lithium orthosilicate powder and the sodium chloride powder was added to the lithium orthosilicate powder.

### EXAMPLE 7

Porous pellets (a carbon dioxide absorbent) were produced in the same manner as Example 1, except that a lithium chloride powder with an average particle diameter of about 1 μm in an amount of 0.5% by mole based on the total amount of the lithium orthosilicate powder and the lithium chloride powder was added to the lithium orthosilicate powder.

### EXAMPLE 8

Porous pellets (a carbon dioxide absorbent) were produced in the same manner as Example 1, except that a lithium chloride powder and a lithium bromide powder each having an average particle diameter of about 1 μm in an amount of 1% by mole each based on the total amount of the lithium orthosilicate powder, the lithium chloride powder, and the lithium bromide powder were added to the lithium orthosilicate powder.

### COMPARATIVE EXAMPLE 1

Silicon dioxide powder with an average particle diameter of 0.8 μm and lithium carbonate powder with an average particle diameter of 1 μm were weighed at a mole ratio of silicon dioxide to lithium carbonate to be 1:2 and mixed in an agate mortar for about 10 minutes in dry state. The obtained powder mixture was heated at 1000° C. for 8 hours in atmospheric air in a box-type electric furnace to obtain a lithium orthosilicate powder. The lithium orthosilicate powder was put in a die with a diameter of 12 mm and pressure molded to produce porous pellets with a porosity of about 40% (a carbon dioxide absorbent).

### COMPARATIVE EXAMPLE 2

Silicon dioxide powder with an average particle diameter of 0.8 μm and lithium carbonate powder with an average particle diameter 1 μm were weighed at a mole ratio of silicon dioxide to lithium carbonate to be 1:2 and mixed in an agate mortar for about 10 minutes in dry state. The obtained powder mixture was heated at 1000° C. for 8 hours in atmospheric air in a box-type electric furnace to obtain a lithium orthosilicate powder. A potassium carbonate powder with an average particle diameter of about 1 μm in an amount of 2% by mole based on the total amount of the lithium orthosilicate powder and the potassium carbonate powder was added to the lithium orthosilicate powder and mixed in an agate mortar in dry state. The lithium orthosilicate powder mixed with the potassium carbonate powder was put in a die with a diameter of 12 mm and pressure molded to produce porous pellets with a porosity of about 40% (a carbon dioxide absorbent).

### COMPARATIVE EXAMPLE 3

Porous pellets (a carbon dioxide absorbent) were produced in the same manner as Comparative Example 2, except that a sodium carbonate powder with an average particle diameter of about 1 μm in an amount of 2% by mole based on the total amount of the lithium orthosilicate powder and the sodium carbonate powder was added to the lithium orthosilicate powder.

With respect to the obtained carbon dioxide absorbents of Examples 1 to 8 and Comparative Examples 1 to 3, the absorption capability and repeating capability of these carbon dioxide absorbents were evaluated by the following methods.

1) Carbon Dioxide Absorption Capability of Carbon Dioxide Absorbent

The carbon dioxide absorption capability was measured by using a thermogravimetric analyzer (TG). The carbon dioxide absorption was carried out by keeping each carbon dioxide absorbent at 600° C. for 1 hour in flow current (1 atmospheric pressure, 300 mL/min) of 10% concentration of carbon dioxide. The carbon dioxide desorption was carried out by keeping each carbon dioxide absorbent at 850° C. for 1 hour in flow current (1 atmospheric pressure, 300 mL/min) of 10% concentration of carbon dioxide. The absorption capability was indicated on the basis of the weight increase ratio (wt/h) for 60 minutes by keeping each carbon dioxide absorbent at 600° C.

2) Repeating Capability of Carbon Dioxide Absorbent

The carbon dioxide absorption and desorption was repeated 100 times in the same temperature condition as described in 1) and the absorption capability at the 100th time was measured in the same manner The repeating capability was evaluated on the basis of the repeating retention ratio. The repeating retention ratio was calculated from the following equation.

Repeating retention ratio=(absorption capability at 100th time)/(absorption capability after first time)

The results of the carbon dioxide absorption capability and the repeating capability were shown in the following Table 1.

TABLE 1

| | | | Absorption | |
|---|---|---|---|---|
| | | | capability | |
| | | | (weight | |
| | | | increase | |
| | | | ratio by | Repeating |
| | | Addition | thermo- | retention |
| | | amount | analaysis | ratio |
| | Type of additive | (mol %) | (wt. %)) | (%) |
| Example 1 | Lithium chloride | 2 | 36 | 93 |
| Example 2 | Lithium bromide | 2 | 36 | 93 |
| Example 3 | Lithium iodide | 2 | 36 | 90 |
| Example 4 | Lithium fluoride | 2 | 36 | 91 |
| Example 5 | Potassium chloride | 2 | 36 | 80 |
| Example 6 | Sodium chloride | 2 | 36 | 82 |
| Example 7 | Lithium chloride | 0.5 | 35 | 90 |
| Example 8 | Lithium chloride | 1 | 36 | 92 |
| | Lithium bromide | 1 | | |
| Comparative | None | 0 | 18 | 5 |
| Example 1 | | | | |
| Comparative | Potassium carbonate | 2 | 32 | 30 |
| Example 2 | | | | |
| Comparative | Sodium carbonate | 2 | 33 | 45 |
| Example 3 | | | | |

As is made clear from Table 1, the carbon dioxide absorbents of Examples 1 to 8 in which the alkali halides were added to lithium silicate had remarkably high a absorption capability as compared with the carbon dioxide absorbent of Comparative Example 1 containing lithium orthosilicate alone and also high as compared with the carbon dioxide absorbents of Comparative Examples 2 and 3 containing lithium silicate and alkali carbonates.

Also, it was found that carbon dioxide absorbents of Examples 1 to 8 in which the alkali halides were added to lithium silicate had higher repeating retention ratio than carbon dioxide absorbents of Comparative Examples 1 to 3.

Accordingly, the carbon dioxide absorbents in which alkali halides were added to lithium silicate were found having high absorption capability and repeating retention ratio.

Particularly, the carbon dioxide absorbents of Examples 1 to 4, 7, and 8 in which lithium halides were added to lithium silicate were found having higher repeating retention ratio than the carbon dioxide absorbents of Examples 5 and 6 in which alkali halides other than lithium halides were added to lithium silicate. Therefore, it is advantageous to use lithium halides as the alkali halide in order to obtain a long-life carbon dioxide absorbent.

In this connection, although in the above-mentioned Examples, lithium orthosilicate was used as the lithium-containing oxide and lithium fluoride, lithium chloride, lithium bromide, lithium iodide, potassium chloride, and sodium chloride were used as the alkali halide, similar effects can be obtained also in the case where other substances selected from lithium-containing oxides and alkali halides are used.

### EXAMPLE 9

Hydrogen was produced by using a reforming apparatus shown in the above-mentioned FIG. 2.

In the reforming apparatus of FIG. 2, a tubular reactor 21 with an inner diameter of 0.05 m and a length of 1.2 m was used. The reactor 21 was filled with 0.4 kg of alumina particles with an average particle diameter of 10 μm bearing 20% by weight of metal nickel as a reforming catalyst 24 and 1.6 kg of lithium orthosilicate granulated to have an average particle diameter of 10 μm and containing 2% by mole of lithium chloride as the carbon dioxide absorbent 25.

Steam and methane were mixed at H₂O/CH₄=3 and the mixed gas was previously heated to 600° C. and introduced into the reactor 21 at 1 L/min ratio from a gas introduction tube 22. The pressure in the reactor 21 was kept at 1 atmospheric pressure.

The methane reforming ratio of the reforming apparatus after 30 minutes from the starting of the operation was calculated according to the following equation.

Methane reforming ratio (%)=100−{(the number of moles of CH₄ in the produced gas discharged per 1 second)/(the number of moles of CH₄ in the mixed gas introduced per 1 second)}×100.

After methane reforming operation was carried out for 30 minutes, carbon dioxide absorbent regeneration operation was carried out for 60 minutes. The carbon dioxide absorbent regeneration operation was carried out by introducing carbon dioxide at 1 L/min into the reactor 21 through the gas introduction tube 22 and heating the reactor 21 to about 850° C. by using a heater 26.

The methane reforming operation and the carbon dioxide absorbent regeneration operation were repeated alternately 20 times. The methane reforming ratio at the 20th time was measured in the same manner as the first time.

### EXAMPLE 10

The methane reforming ratios at the first time and the 20th time were measured in the same manner as described in Example 9, except that lithium orthosilicate granulated to have an average particle diameter of 10 μm and containing 2% by mole of potassium chloride was used as the carbon dioxide absorbent 25.

### COMPARATIVE EXAMPLE 4

The methane reforming ratios at the first time and the 20th time were measured in the same manner as described in Example 9, except that lithium orthosilicate granulated to have an average particle diameter of 10 μm was used as the carbon dioxide absorbent 25.

### COMPARATIVE EXAMPLE 5

The methane reforming ratios at the first time and the 20th time were measured in the same manner as described in Example 9, except that lithium orthosilicate granulated to have an average particle diameter of 10 μm and containing 2% by mole of potassium carbonate was used as the carbon dioxide absorbent 25.

The results are shown in Table 2.

TABLE 2

| | | | Methane | |
|---|---|---|---|---|
| | | | reforming | |
| | | | ratio | Methane |
| | | Addition | (%) at | reforming |
| | | amount | the | ratio (%) at |
| | Type of additive | (mol %) | first time | the 20th time |
| Example 9 | Lithium chloride | 2 | 91 | 90 |
| Example 10 | Potassium chloride | 2 | 90 | 85 |
| Comparative | None | 0 | 75 | 70 |
| Example 4 | | | | |
| Comparative | Potassium carbonate | 2 | 90 | 30 |
| Example 5 | | | | |

As is made clear from Table 2, the methane reforming reaction in Examples 9 and 10 using the carbon dioxide absorbents in which the alkali halides were added to lithium silicate showed higher methane reforming ratio at the first time than the methane reforming reaction in Comparative Example 4 in which the lithium orthosilicate alone was used as the carbon dioxide absorbent. This is because carbon dioxide absorption speed was increased by addition of alkali halide, and the reaction equilibrium in the above-mentioned formula (1) was shifted rightward to promote the methane reforming reaction.

Further, reforming ratio of the methane reforming reaction in Examples 9 and 10 was almost the same at the first time as that of methane reforming in Comparative Example 5 using the carbon dioxide absorbent containing lithium silicate mixed with alkali carbonate, and was higher at the 20th time of repeating the reforming reaction. It was attributed to no alkali element being vaporized in the carbon dioxide absorbents in which alkali halides were added and therefore the reforming catalyst was not poisoned and the catalytic function was maintained as it was.

Accordingly, the reforming reaction using the carbon dioxide absorbent containing an alkali halide can have a high initial reforming ratio and an improved repeating capability.

In this connection, although Example in which orthosilicate was used as the lithium-containing oxide and lithium chloride was used as the alkali halide has been described, similar effects can be obtained also in the case where other substances selected from lithium-containing oxides and alkali halides are used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A carbon dioxide absorbent comprising a lithium-containing oxide and an alkali halide.

2. The absorbent according to claim 1, wherein the lithium-containing oxide is lithium orthosilicate.

3. The absorbent according to claim 1, wherein the alkali halide is lithium halide.

4. The absorbent according to claim 1, wherein the alkali halide is added in an amount of 0.5 to 40% by mole based on the total amount of the lithium-containing oxide and the alkali halide.

5. The absorbent according to claim 1, wherein the alkali halide is added in an amount of 1 to 10% by mole based on the total amount of the lithium-containing oxide and the alkali halide.

6. The absorbent according to claim 1, wherein the absorbent is a porous body.

7. The absorbent according to claim 6, wherein the porous body has a porosity of 30 to 75%.

8. The absorbent according to claim 6, wherein the porous body contains the lithium-containing oxide and the alkali halide respectively existing in the form of granules having an average particle diameter of 0.1 to 10 μm.

9. A carbon dioxide separation apparatus comprising:
a reactor each having a introduction tube and a discharge tube;
a carbon dioxide absorbent charged in the reactor and containing a lithium-containing oxide and an alkali halide; and
a heater installed in the outer circumference of the reactor for supplying heat to the reactor.

10. The carbon dioxide separation apparatus according to claim 9, wherein the lithium-containing oxide in the carbon dioxide absorbent is lithium orthosilicate and the alkali halide is lithium halide.

11. The carbon dioxide separation apparatus according to claim 9, wherein the alkali halide in the carbon dioxide absorbent is added in an amount of 0.5 to 40% by mole based on the total amount of the lithium-containing oxide and the alkali halide.

12. The carbon dioxide separation apparatus according to claim 9, wherein the carbon dioxide absorbent is a porous body.

13. The carbon dioxide separation apparatus according to claim 12, wherein the porous body contains the lithium-containing oxide and the alkali halide respectively existing in the form of granules having an average particle diameter of 0.1 to 10 μm and has a porosity of 30 to 75%.

14. A reforming apparatus comprising:
a reactor having an introduction tube to introduce steam and a starting material gas containing carbon, and a discharge tube to discharge produced gases;
a reforming catalyst charged in the reactor to promote the reforming reaction;
a carbon dioxide absorbent charged in the reactor and containing a lithium-containing oxide and an alkali halide; and
a heater installed in the outer circumference of the reactor to supply heat to the reactor.

15. The reforming apparatus according to claim 14, wherein the reforming catalyst is an alumina carrier supporting a catalyst metal selected from nickel, ruthenium and rhodium.

16. The reforming apparatus according to claim 14, wherein the lithium-containing oxide in the carbon dioxide absorbent is lithium orthosilicate and the alkali halide is lithium halide.

17. The reforming apparatus according to claim 14, wherein the alkali halide in the carbon dioxide absorbent is added in an amount of 0.5 to 40% by mole based on the total amount of the lithium-containing oxide and the alkali halide.

18. The reforming apparatus according to claim 14, wherein the carbon dioxide absorbent is a porous body.

19. The reforming apparatus according to claim 18, wherein the porous body contains the lithium-containing oxide and the alkali halide respectively existing in the form of granules having an average particle diameter of 0.1 to 10 μm and has a porosity of 30 to 75%.

20. The reforming apparatus according to claim 14, wherein the reforming catalyst and the carbon dioxide absorbent are charged in the reactor at a weight ratio of the reforming catalyst to the carbon dioxide absorbent to be in the range of 1:1 to 1:8.
